(19) United States
(12) Patent Application Publication
(10) Pub. No.: US 2011/0310480 A1
(43) Pub. Date: Dec. 22, 2011

(54) STEREOSCOPIC IMAGE OBSERVATION OPTICAL-ELEMENT, STEREOSCOPIC IMAGE OBSERVATION GLASSES, AND STEREOSCOPIC IMAGE DISPLAY SYSTEM

(75) Inventors: Mitsunari Hoshi, Miyagi (JP); Hitoshi Katakura, Miyagi (JP); Jun Shimizu, Miyagi (JP)

(73) Assignee: SONY CORPORATION, Tokyo (JP)

(21) Appl. No.: 13/154,978

(22) Filed: Jun. 7, 2011

(30) Foreign Application Priority Data
Jun. 16, 2010 (JP) 2010-137261

(51) Int. Cl. G02B 27/22

(52) U.S. Cl. 359/465

(57) ABSTRACT

A stereoscopic image observation optical-element includes: a laminated member including a λ/4 phase-difference member and a polarizing member. The λ/4 phase-difference member is provided on a light incidence surface side and has a slow axis in a first direction, and the polarizing member is provided nearer to a light emission side than the λ/4 phase-difference member and has a transmission axis in a direction crossing the first direction at substantially 45 degrees. The laminated member has a curved shape projecting to the light incidence surface side, and the λ/4 phase-difference member is configured of a material having a photoelastic coefficient of less than about 80*10⁻¹²/Pa.

### CROSS REFERENCES TO RELATED APPLICATIONS

The present application claims priority to Japanese Priority Patent Application JP 2010-137261 filed in the Japan Patent Office on Jun. 16, 2010, the entire content of which is hereby incorporated by reference.

### BACKGROUND

The present application relates to a stereoscopic image observation optical-element used for observing a stereoscopic image, and to stereoscopic image observation glasses used for the same. In addition, the application relates to a stereoscopic image display system using the stereoscopic image observation glasses.

Recently, various manufacturers have released display devices displaying a three-dimensional (3D) image one after another. When 3D images are viewed by using such display devices, special glasses (polarized glasses) have been typically necessary to be used. The polarized glasses for 3D display are disclosed in many documents (see Japanese Patent No. 4154653, and Japanese Unexamined Patent Application Publication Nos. 2003-167216, 2002-196281, H10-206796 and H09-138371).

SUMMARY

The polarized glasses have limitedly had flat lenses. This is because if the glasses have lenses being curved, 3D image formation becomes difficult. Therefore, the polarized glasses for 3D display have been limited in degree of freedom in design.

It is desirable to provide a stereoscopic image observation optical-element and stereoscopic image observation glasses, those having a high degree of freedom in design. Furthermore, it is desirable to provide a stereoscopic image display system using the stereoscopic image observation glasses.

A stereoscopic image observation optical-element according to an embodiment includes: a laminated member including a λ/4 phase-difference member and a polarizing member. The λ/4 phase-difference member is provided on a light incidence surface side and has a slow axis in a first direction, and the polarizing member is provided nearer to a light emission side than the λ/4 phase-difference member and has a transmission axis in a direction crossing the first direction at substantially 45 degrees. The laminated member has a curved shape projecting to the light incidence surface side, and the λ/4 phase-difference member is configured of a material having a photoelastic coefficient of less than about 80*10⁻¹²/Pa.

The photoelastic coefficient (stress-optical coefficient) corresponds to a quantity indicating a magnitude of a photoelastic effect. The photoelastic effect refers to a phenomenon that when a material is applied with external force and thus distorted, optical anisotropy is induced and thus birefringence occurs in the material. The photoelastic coefficient is defined by the following expressions.

|CR|=|Δn|/σR

|Δn|=|n1−n2|

In the expressions, |CR| denotes an absolute value of a photoelastic coefficient, σR denotes extensional stress, |Δn| denotes an absolute value of birefringence, n1 denotes a refractive index in an extension direction, and n2 denotes a refractive index in a direction perpendicular to the extension direction. The expressions indicate that as a value of the photoelastic coefficient is closer to zero, change in birefringence due to external force is reduced. The photoelastic coefficient of the λ/4 phase-difference member is smaller than a photoelastic coefficient (about 80*10⁻¹²/Pa) of a PC (polycarbonate), and preferably about 50*10⁻¹²/Pa or less, and more preferably about 30*10⁻¹²/Pa or less. The material having the photoelastic coefficient within the above range includes, for example but not limited to, a modified PC (polycarbonate). The modified PC refers to a material where a molecular structure (framework) of a PC is partially modified to improve symmetry of the molecular structure.

Stereoscopic image observation glasses according to an embodiment include: a first optical element for a right eye; a second optical element for a left eye; and a frame supporting the first optical element and the second optical element. The first optical element includes a first laminated member having a first λ/4 phase-difference member and a first polarizing member. The first λ/4 phase-difference member is provided on a light incidence surface side and has a slow axis in a first direction, and the first polarizing member is provided nearer to a light emission side than the first λ/4 phase-difference member and has a transmission axis in a direction crossing the first direction at substantially 45 degrees. The second optical element includes a second laminated member having a second λ/4 phase-difference member and a second polarizing member. The second λ/4 phase-difference member is provided on a light incidence surface side and has a slow axis in a second direction crossing the first direction, and the second polarizing member is provided nearer to a light emission side than the second λ/4 phase-difference member and has a transmission axis in a direction crossing the second direction at substantially 45 degrees. Each of the first laminated member and the second laminated member has a curved shape projecting to the light incidence surface side, and each of the first λ/4 phase-difference member and the second λ/4 phase-difference member is configured of a material having a photoelastic coefficient of less than about 80*10⁻¹²/Pa.

A stereoscopic image display system according to an embodiment includes: a stereoscopic image display device; and stereoscopic image observation glasses provided separately from the stereoscopic image display device. The stereoscopic image observation glasses include: a first optical element for a right eye; a second optical element for a left eye; and a frame supporting the first optical element and the second optical element. The first optical element includes a first laminated member having a first λ/4 phase-difference member and a first polarizing member. The first λ/4 phase-difference member is provided on a light incidence surface side and has a slow axis in a first direction, and the first polarizing member is provided nearer to a light emission side than the first λ/4 phase-difference member and has a transmission axis in a direction crossing the first direction at substantially 45 degrees. The second optical element includes a second laminated member having a second λ/4 phase-difference member and a second polarizing member. The second λ/4 phase-difference member is provided on a light incidence surface side and has a slow axis in a second direction crossing the first direction, and the second polarizing member is provided nearer to a light emission side than the second λ/4 phase-difference member and has a transmission axis in a direction crossing the second direction at substantially 45 degrees. Each of the first laminated member and the second laminated member has a curved shape projecting to the light incidence surface side, and each of the first λ/4 phase-difference member and the second λ/4 phase-difference member is configured of a material having a photoelastic coefficient of less than about 80*10⁻¹²/Pa.

In the stereoscopic image observation optical-element, the stereoscopic image observation glasses, and the stereoscopic image display system according to the embodiments of the technology, the λ/4 phase-difference members (the first λ/4 phase-difference member and the second λ/4 phase-difference member) are configured of the material having the photoelastic coefficient of less than about 80*10⁻¹²/Pa. Thus, even if the λ/4 phase-difference members are manufactured while being applied with stress during manufacturing, the stress does not cause significant change in birefringence. Therefore, even if the laminated member is formed into a curved shape projecting to a display device side, a change in an optical characteristic due to stress is reduced compared with in the past.

According to the stereoscopic image observation optical-element, the stereoscopic image observation glasses, and the stereoscopic image display system of the embodiments of the technology, even if the laminated member is formed into a curved shape projecting to a display device side, a change in an optical characteristic due to stress is reduced compared with in the past. Thus, the laminated member is improved in design, or a shape of the frame is designed relatively freely. As a result, the stereoscopic image observation optical-element and the stereoscopic image observation glasses, each of which has a high degree of freedom in design, are provided. In addition, the stereoscopic image display system using the stereoscopic image observation glasses having a high degree of freedom in design is provided. Further, for example, when a curvature of the curved laminated member is made relatively large in a light incidence side and relatively small in a light emission side, a visual correction function is added to the laminated member. In such a case, the degree of freedom is improved not only in design but also in function.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

The accompanying drawings are included to provide a further understanding of the application, and are incorporated in and constitute a part of this specification. The drawings illustrate embodiments and, together with the specification, serve to explain the principles of the technology.

FIG. 1 is a perspective diagram showing an example of a configuration of polarizing glasses according to an embodiment, together with a configuration of a display device.

FIGS. 2A and 2B are perspective diagrams showing another example of a configuration of the polarizing glasses of FIG. 1.

FIGS. 3A and 3B are perspective diagrams showing an example of a configuration of each of a right-eye optical element and a left-eye optical element of the polarizing glasses of FIG. 1.

FIGS. 4A and 4B are conceptual diagrams showing an example of a slow axis of each of the right-eye optical element and the left-eye optical element of FIGS. 3A and 3B, together with a slow axis or a transmission axis of another optical element.

FIGS. 5A and 5B are conceptual diagrams for illustrating an example of a slow axis and a transmission axis in the case that an image on the display device of FIG. 1 is observed by a right eye.

FIGS. 6A and 6B are conceptual diagrams for illustrating another example of the slow axis and the transmission axis in the case that an image on the display device of FIG. 1 is observed by the right eye.

FIGS. 7A and 7B are conceptual diagrams for illustrating an example of a slow axis and a transmission axis in the case that an image on the display device of FIG. 1 is observed by a left eye.

FIGS. 8A and 8B are conceptual diagrams for illustrating another example of the slow axis and the transmission axis in the case that an image on the display device of FIG. 1 is observed by the left eye.

FIG. 9 is a perspective diagram showing another example of the configuration of each of the right-eye optical element and the left-eye optical element of the polarizing glasses of FIG. 1.

FIG. 10 is a section diagram showing an example of a configuration of the display device of FIG. 1.

FIG. 11 is a perspective diagram showing an example of a configuration of a phase difference element in FIG. 10.

FIGS. 12A and 12B are a perspective diagram and a diagram showing an example of a configuration of an alignment film in FIG. 11.

FIG. 13 is a graph showing a measurement result of crosstalk in polarized glasses according to each of an example and a comparative example.

### DETAILED DESCRIPTION

Embodiments of the present application will be described below in detail with reference to the drawings.

1. Embodiment

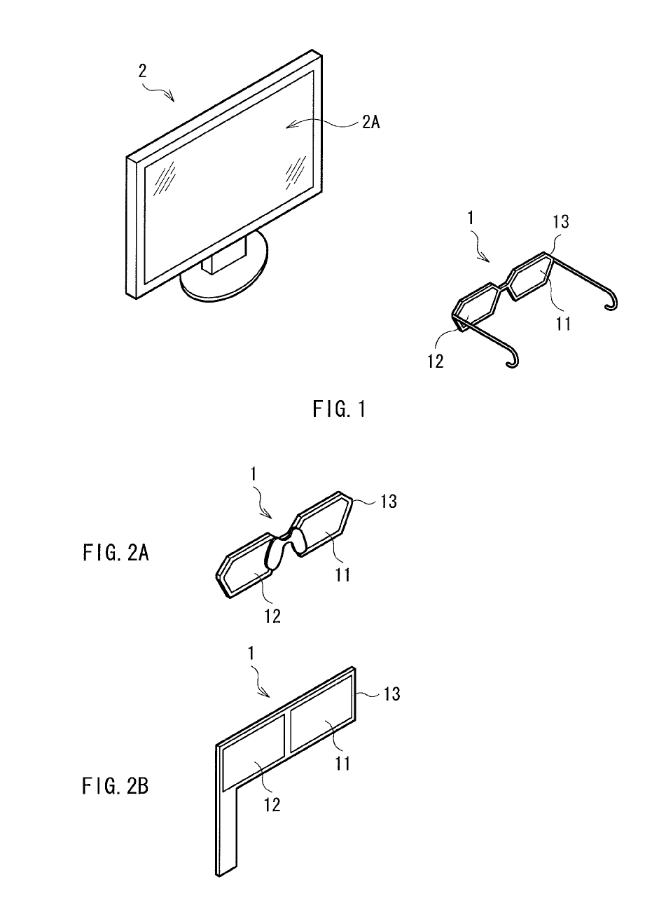

1.1 Configuration of polarized glasses 1 (FIGS. 1 to 9)

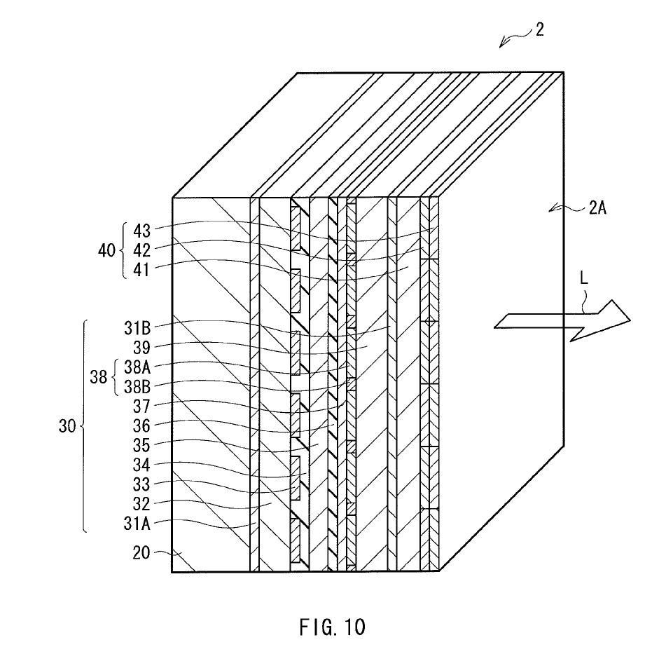

1.2 Configuration of display device 2 (FIGS. 10 to 12B)

1.3 Basic operation

1.4 Advantages

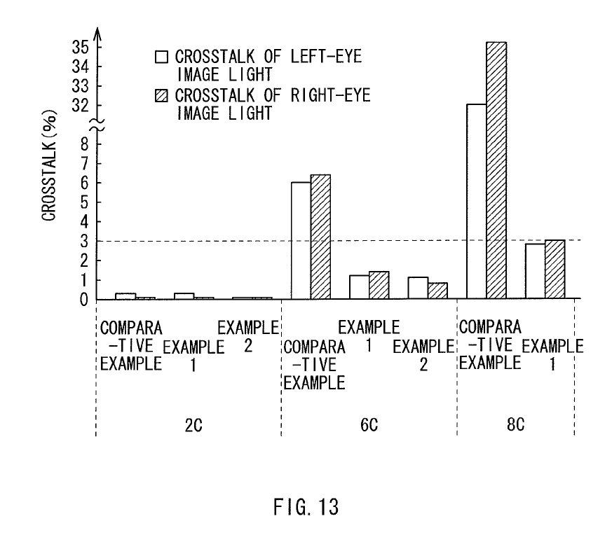

2. Example (FIG. 13)

3. Modifications

(1. Embodiment)

(1.1 Configuration of Polarized Glasses 1)

FIG. 1 perspectively shows an example of a configuration of polarized glasses 1 according to an embodiment, together with a configuration of a polarized-glass-type display device 2 described later. The polarized glasses 1 correspond to a specific example of “stereoscopic image observation glasses” of an embodiment, and the polarized glasses 1 combined with the display device 2 corresponds to a specific example of “stereoscopic image display system” of an embodiment.

The polarized glasses 1 according to the embodiment are to be worn in front of eye balls of an observer (not shown), and when an observer observes an image projected on an image display surface 2A of the display device 2, the observer uses the polarized glasses. The polarized glasses 1 are, for example, circularly polarized glasses, and, for example, have a right-eye optical element 11, a left-eye optical element 12, and a frame 13 as shown in FIG. 1. The right-eye optical element 11 corresponds to a specific example of “stereoscopic image observation optical-element” or “first optical element” of an embodiment, and the left-eye optical element 12 corresponds to a specific example of “stereoscopic image observation optical-element” or “second optical element” of an embodiment.

The frame 13 supports the right-eye optical element 11 and the left-eye optical element 12. The frame 13 is not particularly limitedly shaped, but, for example, may be shaped to be hung on a nose and ears of an observer (not shown) as shown in FIG. 1, or shaped to be hung on only a nose of an observer as shown in FIG. 2A. Alternatively, for example, the frame 13 may be shaped to be grasped by a hand of an observer as shown in FIG. 2B.

The right-eye optical element 11 and the left-eye optical element 12 are used facing the image display surface 2A of the display device 2. While the right-eye optical element 11 and the left-eye optical element 12 are preferably used being disposed in one horizontal plane as shown in FIG. 1 to the utmost, the elements may be used being disposed in a plane being somewhat inclined.

The right-eye optical element 11 has, for example, a right-eye phase-difference plate 11A, a polarizing plate (polarizing member) 11B, and a support 11C. The right-eye phase-difference plate 11A, the polarizing plate 11B, and the support 11C are disposed in order from an incident side (a display device 2 side) of light L emitted from the image display surface 2A of the display device 2. The left-eye optical element 12 has, for example, a left-eye phase-difference plate 12A, a polarizing plate (polarizing member) 12B, and a support 12C. The left-eye phase-difference plate 12A, the polarizing plate 12B, and the support 12C are disposed in order from the incident side (a display device 2 side) of the light L emitted from the image display surface 2A of the display device 2. A laminated plate including the right-eye phase-difference plate 11A, the polarizing plate 11B, and the support 11C corresponds to a specific example of “laminated member” or “first laminated member” of an embodiment the technology. A laminated plate including the left-eye phase-difference plate 12A, the polarizing plate 12B, and the support 12C corresponds to a specific example of “laminated member” or “second laminated member” of an embodiment. The right-eye phase-difference plate 11A corresponds to a specific example of “λ/4 phase-difference member” or “first λ/4 phase-difference member” of an embodiment, and the left-eye phase-difference plate 12A corresponds to a specific example of “λ/4 phase-difference member” or “second λ/4 phase-difference member” of an embodiment.

The support 11C or 12C may be omitted as necessary. The right-eye optical element 11 or the left-eye optical element 12 may have a member other than the members as exemplified above. For example, a protective film (not shown) for preventing scattering of broken pieces of the support 11C or 12C to an eye ball of an observer in the case of breakage of the support, or a protective coating layer (not shown) for protection may be provided on a surface on a light emission side (an observer side) of the support.

For example, the support 11C supports the right-eye phase-difference plate 11A and the polarizing plate 11B. For example, the support 11C includes resin transparent to the light L emitted from the image display surface 2A of the display device 2, such as PC (polycarbonate), for example. For example, the support 12C supports the left-eye phase-difference plate 12A and the polarizing plate 12B. For example, the support 12C includes resin transparent to the light L emitted from the image display surface 2A of the display device 2, such as PC (polycarbonate).

The polarizing plate 11B or 12B transmits only light (polarized light) in a certain oscillation direction. For example, each of polarizing axes AX1 and AX2 of the polarizing plates 11B and 12B is in a direction perpendicular to a polarizing axis AX3 of a polarizing plate 31B (described later) of the display device 2 as shown in FIGS. 4A and 4B. For example, when the polarizing axis AX3 of the polarizing plate 31B is in a vertical direction, the polarizing axes AX1 and AX2 are in a horizontal direction as shown in FIG. 4A, and, for example, when the polarizing axis AX3 of the polarizing plate 31B is in a horizontal direction, the polarizing axes AX1 and AX2 are in a vertical direction as shown in FIG. 4B. While not shown, when the polarizing axis AX3 of the polarizing plate 31B is in an oblique (a 45-degree) direction, the polarizing axes AX1 and AX2 are in a direction (−45-degree direction) perpendicular to the oblique direction.

The right-eye phase-difference plate 11A and the left-eye phase-difference plate 12A include thin layers having optical anisotropy each. These phase-difference plates are configured of a material having a photoelastic coefficient smaller than a photoelastic coefficient (80*10⁻¹²/Pa) of PC (polycarbonate). The phase-difference plates are preferably configured of a material having a photoelastic coefficient of 50*10⁻¹²/Pa or less, and more preferably configured of a material having a photoelastic coefficient of 30*10⁻¹²/Pa or less. A resin material having such a property includes, for example, modified PC (polycarbonate). Modified PC refers to a material where a molecular structure (framework) of typical PC is partially modified so as to improve symmetry of the molecular structure. The right-eye phase-difference plate 11A and the left-eye phase-difference plate 12A include, for example, modified PC (polycarbonate). When the resin material as exemplified above is used for a base of each of the right-eye phase-difference plate 11A and the left-eye phase-difference plate 12A, the base may be complexed with a fiber such as nonwoven fabric or filler. Other than the modified PC, a material having a small photoelastic coefficient may include PMMA (polymethylmethacrylate), PS (polystyrene), TAC (triacetylcellulose), COP (cycloolefin polymer), or COC (cycloolefin copolymer), or a blend thereof. A blend of PC and PS may be formed by using a method disclosed in Japanese Unexamined Patent Application Publication No. 2001-55455. However, the modified PC is preferable because of high shock resistance or high heat resistance (high glass transition temperature Tg) thereof.

A slow axis AX4 of the right-eye phase-difference plate 11A is in a direction crossing the polarizing axis AX1 at 45 degrees, as shown in FIGS. 4A and 4B. A slow axis AX5 of the left-eye phase-difference plate 12A is in a direction crossing the polarizing axis AX2 at 45 degrees, the direction being perpendicular to the slow axis AX4, as shown in FIGS. 4A and 4B. For example, when the polarizing axes AX1 and AX2 are in a horizontal or vertical direction, each of the slow axes AX4 and AX5 is in a direction crossing each of the horizontal and vertical directions, as shown in FIGS. 4A and 4B. While not shown, when the polarizing axes AX1 and AX2 are in an oblique (a 45-degree) direction, the slow axis AX4 is, for example, in a horizontal direction, and the slow axis AX5 is, for example, in a vertical direction.

The slow axis AX4 is in the same direction as a direction of a slow axis AX6 of a right-eye phase-difference region 43A described later, the direction being different from a direction of a slow axis AX7 of a left-eye phase-difference region 43B described later. The slow axis AX5 is in the same direction as a direction of the slow axis AX7, the direction being different from a direction of the slow axis AX6.

(Retardation)

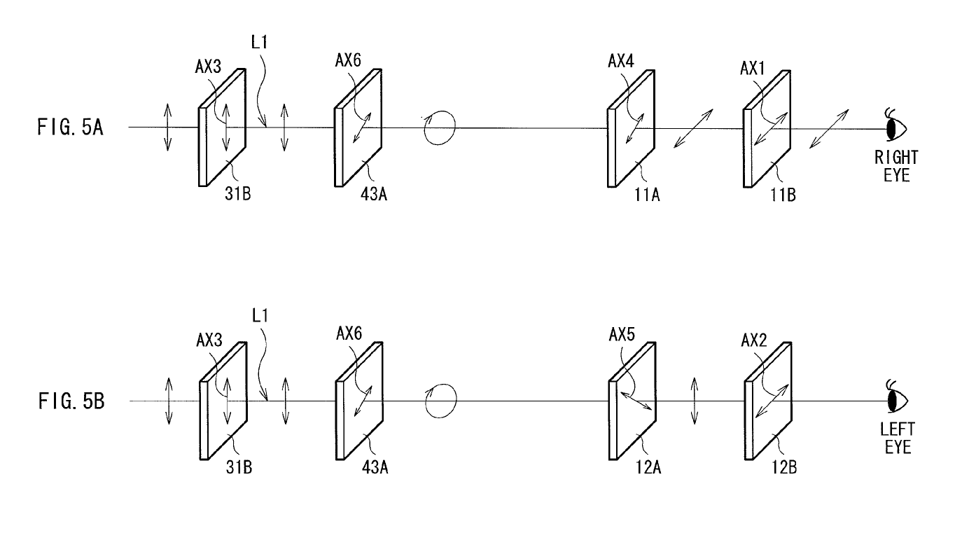

Next, retardation of the polarized glasses 1 is described with reference to FIGS. 5A and 5B to FIGS. 8A and 8B. For describing retardation of the polarized glasses 1, a phase difference element 40 (described later) mounted in the display device 2 needs to be understood. Since description of the phase difference element 40 is made in detail later, retardation of the polarized glasses 1 is described herein quoting symbols used in the description. Retardation may be measured by several kinds of elliptic polarization analysis such as the rotating analyzer or the Senarmont method. In this specification, values obtained by using the rotating analyzer are shown as values of the retardation.

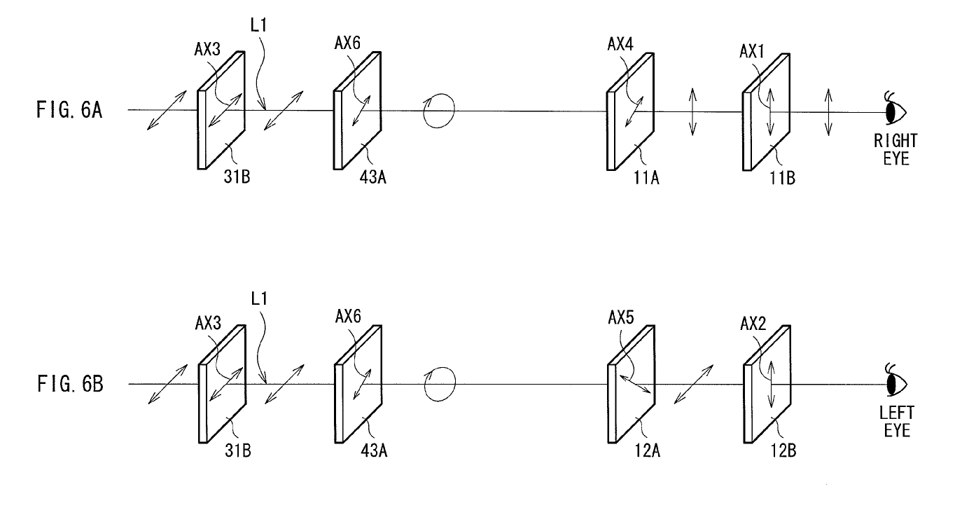

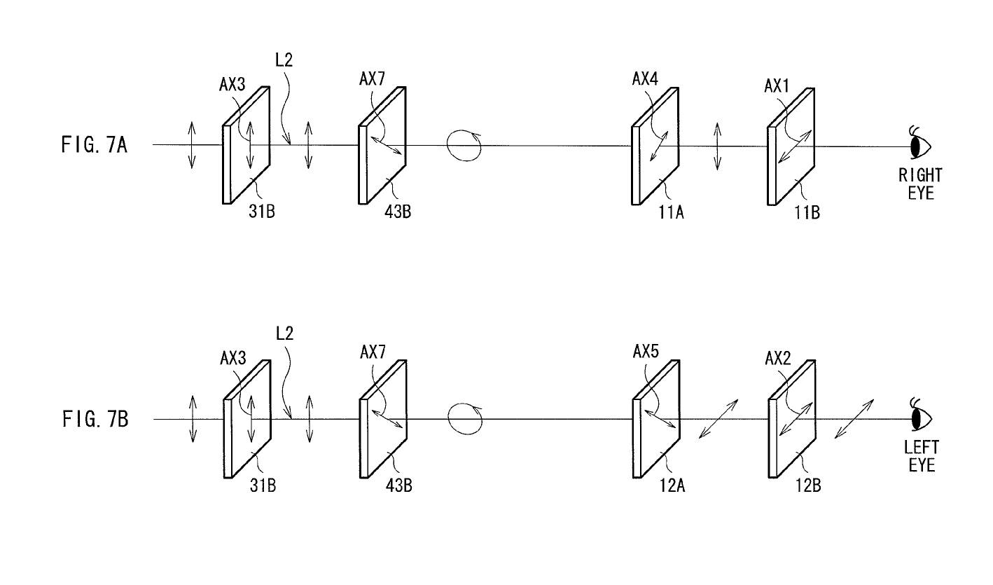

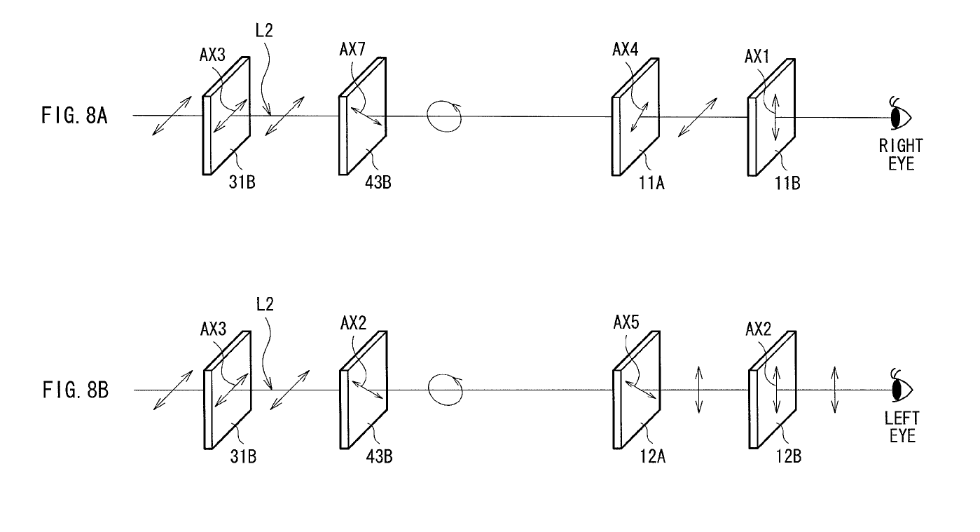

FIGS. 5A and 5B and FIGS. 6A and 6B are conceptual diagrams illustrating, while attention is focused on only right-eye image light L1 entering the right-eye phase-difference region 43A of the phase-difference layer 43, how the light L1 is recognized by two eyes through the polarized glasses 1. FIGS. 7A and 7B and FIGS. 8A and 8B are conceptual diagrams illustrating, while attention is focused on only left-eye image light L2 entering the left-eye phase-difference region 43B of the phase-difference layer 43, how the light L2 is recognized by two eyes through the polarized glasses 1. While the right-eye image light L1 and the left-eye image light L2 are actually mixedly outputted, the light L1 and the light L2 are separately described for convenience of explanation in FIGS. 5A and 5B to FIGS. 8A and 8B.

When an image display surface of the display device 2 is observed using the polarized glasses 1, it is necessary to allow an image of right-eye pixels to be recognized by a right eye, and to allow the image not to be recognized by a left eye, for example, as shown in FIGS. 5A and 5B and FIGS. 6A and 6B. Also, it is necessary to allow an image of left-eye pixels to be recognized by a left eye, and to allow the image not to be recognized by a right eye, for example, as shown in FIGS. 7A and 7B and FIGS. 8A and 8B. To achieve this, retardation of each of the right-eye phase-difference region 43A and the right-eye phase-difference plate 11A and retardation of each of the left-eye phase-difference region 43B and the left-eye phase-difference plate 12A are preferably set as follows.

Specifically, it is preferable that retardation of one of the right-eye phase-difference plate 11A and the left-eye phase-difference plate 12A be +λ/4 (λ is wavelength), and retardation of the other be −λ/4. Opposite signs of the two kinds of retardation represent that directions of the respective slow axes are different by 90 degrees. Here, retardation of the right-eye phase-difference region 43A is preferably the same as retardation of the right-eye phase-difference plate 11A, and retardation of the left-eye phase-difference region 43B is preferably the same as retardation of the left-eye phase-difference plate 12A.

Actually, it is not easy to select a material, which may be adjusted in retardation to be λ/4 over all wavelengths (the entire visible range), for each of the right-eye phase-difference plate 11A and the left-eye phase-difference plate 12A. However, it is more important that retardation of the right-eye phase-difference region 43A be the same as (or similar in value to) retardation of the right-eye phase-difference plate 11A over all wavelengths, and retardation of the left-eye phase-difference region 43B be the same as (or similar in value to) retardation of the left-eye phase-difference plate 12A over all wavelengths, than adjusting the retardation to be λ/4 over all wavelengths. While the retardation need not be adjusted to be λ/4 over all wavelengths, the retardation is preferably adjusted to be λ/4 within a green range of approximately 500 to 560 nm in order to view a 3D image with high luminance and an appropriate color. This is because human retinas have high sensitivity to light in a green wavelength range, and because when retardation is appropriately adjusted in a green range, retardation in a blue or red range is also adjusted relatively appropriately.

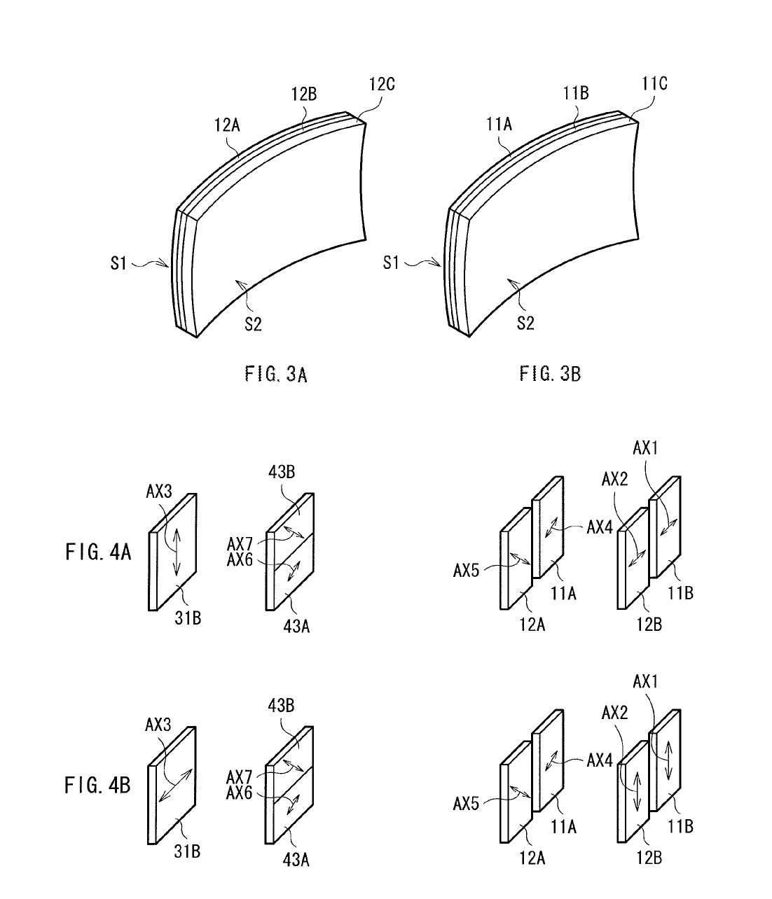

In this embodiment, each of the right-eye optical element 11 and the left-eye optical element 12 does not have a flat shape, and has a curved shape projecting to an incident side (display device 2 side) of the light L emitted from the image display surface of the display device 2. Each of the right-eye optical element 11 and the left-eye optical element 12 has, for example, a shape formed by curving a flat plate, and, for example, has a convex curved-surface on a surface (light incident surface S1) on a display device 2 side and a concave curved-surface on a surface (light emitting surface S2) on an observer side, as shown in FIG. 3.

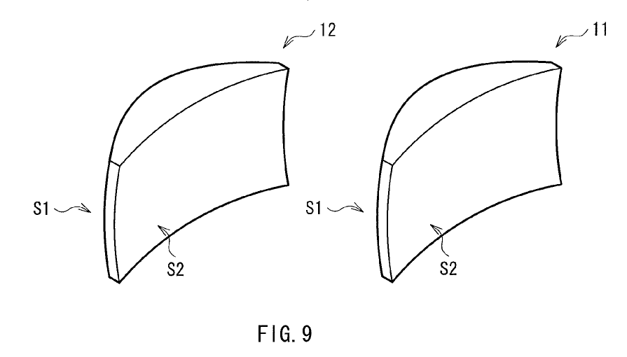

Each of curvature (hereinafter, called curvature A) of the convex curved-surface formed on the light incident surface S1 and curvature (hereinafter, called curvature B) of the concave curved-surface formed on the light emitting surface S2 has a curvature equal to or larger than the curvature of 8C lens. The 8C, which defines a certain curvature of a glass lens, means a curvature of 65.4 mm. The curvature A and the curvature B may be equal to or different from each other. When the curvature A and the curvature B are different from each other, the curvature A is preferably larger than the curvature B, for example, as shown in FIG. 9. In such a case, for example, each of the right-eye optical element 11 and the left-eye optical element 12 functions even as a visual correction lens.

### (1.2 Configuration of Display Device 2)

Next, an example of a configuration of the display device 2 used with the polarized glasses 1 is described. FIG. 10 shows an example of a sectional configuration of the display device 2. The display device 2 is configured by stacking a backlight unit 20, a liquid crystal display panel 30 (display panel), and a phase difference element 40 in this order. In the display device 2, a surface of the phase difference element 40 corresponds to the image display surface 2A, and is set toward an observer. In this embodiment, the display device 2 is disposed in such a manner that the image display surface 2A is parallel to a vertical surface (perpendicular surface). The observer observes the image display surface 2A wearing the polarized glasses 1 in front of eye balls of the observer.

(Backlight Unit 20)

The backlight unit 20 has, for example, a reflecting plate, a light source, and an optical sheet (each being not shown). The reflecting plate returns emission light from the light source to an optical sheet side, and has functions of reflection, scattering, and diffusion of light. The reflecting plate is configured of, for example, PET (polyethylene terephthalate) foam. Consequently, emission light from the light source is efficiently used. The light source, which illuminates the liquid crystal panel 30 from the back, includes, for example, a plurality of linear light sources arranged in parallel at even intervals or a plurality of dot-like light sources arranged two-dimensionally. The linear light source includes such as a hot cathode fluorescent lamp (HCFL) and a cold cathode fluorescent lamp (CCFL), for example. The dot-like light source includes, for example, a light emitting diode (LED). The optical sheet makes uniform in-plane luminance distribution of light from the light source, or adjusts a divergence angle or a polarized state of the light within a desired range, and, for example, includes a diffuser plate, a diffuser sheet, a prism sheet, a reflection-type polarizing element, or a phase-difference plate. The light source may be an edge-light-type light source. In such a case, a light guide plate or a light guide film is used as necessary.

### (Liquid Crystal Display Panel 30)

The liquid crystal display panel 30 is a transmissive display panel, having a plurality of pixels arranged two-dimensionally in row and column directions, and is to display an image by driving the pixels according to an image signal. The liquid crystal display panel 30 has, for example, a polarizing plate 31A, a transparent substrate 32, pixel electrodes 33, an alignment film 34, a liquid crystal layer 35, an alignment film 36, a common electrode 37, a color filter 38, a transparent electrode 39, and a polarizing plate 31B, in order from a backlight unit 20 side, as shown in FIG. 10.

The polarizing plate 31A is disposed on a light incidence side of the liquid crystal display panel 30, and the polarizing plate 31B is disposed on a light emission side thereof. The polarizing plate 31A or 31B is a kind of optical shutter, and transmits only light (polarized light) in a certain oscillation direction. For example, the polarizing plates 31A and 31B are disposed such that polarizing axes of the plates are different by a predetermined angle (for example, 90 degrees) from each other, so that emission light from the backlight unit 20 is transmitted or blocked by the liquid crystal layer. A shape of each polarizing plate is not limited to a plate-like shape.

A direction of a transmission axis of the polarizing plate 31A is set within a range where light emitted from the backlight unit 20 is transmittable. For example, when a polarizing axis of light emitted from the backlight unit 20 is in a vertical direction, the transmission axis of the polarizing plate 31A is also in the vertical direction, and when the polarizing axis of light emitted from the backlight unit 20 is in a horizontal direction, the transmission axis of the polarizing plate 31A is also in the horizontal direction. Light emitted from the backlight unit 20 is not limited to linearly polarized light, and may be circularly or elliptically polarized light or non-polarized light.

A direction of a polarizing axis of the polarizing plate 31B is set within a range where light transmitted by the liquid crystal display panel 30 is transmittable. For example, when the polarizing axis of the polarizing plate 31A is in the horizontal direction, the polarizing axis of the polarizing plate 31B is in a direction (vertical direction) perpendicular to the polarizing axis of the polarizing plate 31A. For example, when the polarizing axis of the polarizing plate 31A is in the vertical direction, the polarizing axis of the polarizing plate 31B is in a direction (horizontal direction) perpendicular to the polarizing axis of the polarizing plate 31A. The polarizing axis is the same meaning as the transmission axis.

Typically, the transparent substrate 32 or 39 is transparent to visible light. For example, an active drive circuit, including TFTs (Thin Film Transistors) as drive elements electrically connected to the pixel electrodes 33 and wiring lines, is formed on the transparent substrate on a backlight unit 20 side. The pixel electrodes 33 include, for example, indium tin oxide (ITO), and serve as electrodes for each pixel. The alignment film 34 or 36 includes, for example, a polymer material such as polyimide, for performing alignment treatment of liquid crystal. The liquid crystal layer 35 includes, for example, VA (Vertical Alignment)-mode liquid crystal, IPS (In-Plane Switching)-mode liquid crystal, TN (Twisted Nematic)-mode liquid crystal or STN (Super Twisted Nematic)-mode liquid crystal. The liquid crystal layer 35 has a function of transmitting or blocking emission light from the backlight unit 20 for each pixel depending on applied voltage from a not-shown drive circuit. The common electrode 37 includes, for example, ITO, and serves as a common counter electrode to the pixel electrodes 33. The color filter 38 is formed by arranging filter sections 38A for color separation of emission light from the backlight unit 20 into, for example, three primary colors of red (R), green (G) and blue (B). In the color filter 38, a black matrix section 38B having a shading function is provided in a portion corresponding to each boundary between pixels.

(Phase Difference Element 40)

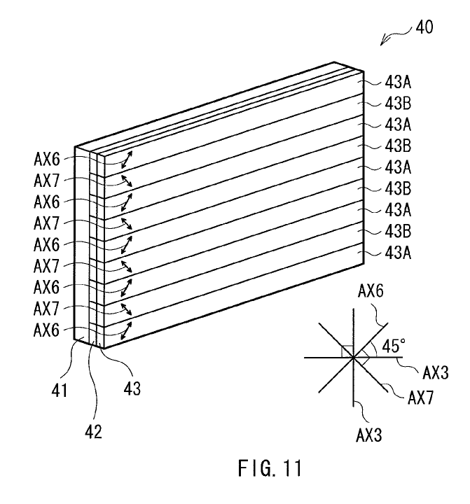

Next, the phase difference element 40 is described. FIG. 11 perspectively shows an example of a configuration of the phase difference element 40. The phase difference element 40 changes a polarizing state of light which has transmitted through the polarizing plate 31B of the liquid crystal display panel 30. The phase difference element 40 is attached to a surface (polarizing plate 31B) on a light emission side of the liquid crystal display panel 30 by an adhesive (not shown) or the like. For example, the phase difference element 40 has a base 41, an alignment film 42, and a phase difference layer 43, in order from a liquid crystal display panel 30 side. While not shown, the base 41, the alignment film 42, and the phase difference layer 43 may be disposed in order from a side (observer side) opposite to the liquid crystal display panel 30 side.

The base 41 supports the alignment film 42 and the phase difference layer 43, and is configured of, for example, a transparent resin film. The transparent resin film is preferably small in optical anisotropy, namely, small in birefringence. A transparent resin film having such a property includes, for example, TAC (triacetylcellulose), COP (cycloolefin polymer), COC (cycloolefin copolymer), and PMMA (polymethylmethacrylate). COP includes, for example, ZEONOR or ZEONEX (registered trademark of ZEON CORPORATION), and ARTON (registered trademark of JSR Corporation). For example, thickness of the base film 41 is preferably 30 μm to 500 μm. Retardation of the base 41 is preferably 20 nm or less, and more preferably 10 nm or less. The base 41 may be configured of a glass substrate.

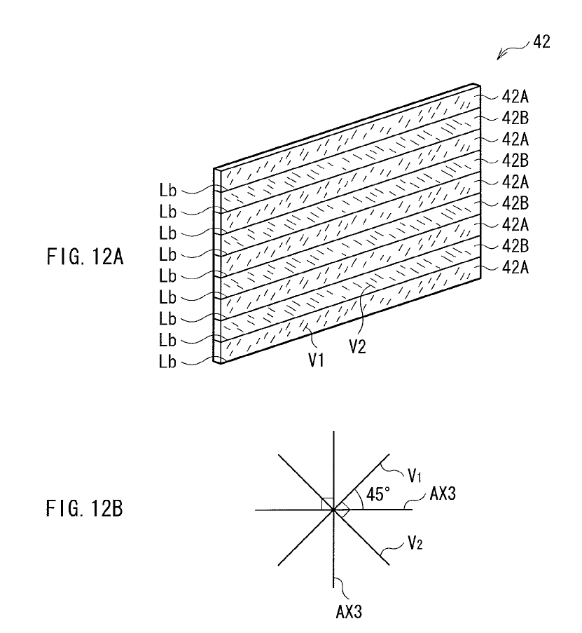

The alignment film 42 has a function of aligning an alignable material such as liquid crystal in a particular direction. The alignment film 42 is configured of transparent resin, for example, UV-curing or EB-curing transparent resin, or thermoplastic transparent resin. The alignment film 42 is provided on a surface on a light emission side of the base 41, and, for example, has two kinds of alignment regions (a right-eye alignment region 42A and a left-eye alignment region 42B) having different alignment directions, as shown in FIG. 12A. The right-eye alignment region 42A and the left-eye alignment region 42B have, for example, a belt-like shape extending in a common, one direction (horizontal direction) each, and alternately disposed in a short-side direction (vertical direction) of the right-eye alignment region 42A or the left-eye alignment region 42B. The right-eye alignment region 42A and the left-eye alignment region 42B are disposed in correspondence to pixels of the liquid crystal display panel 30, and, for example, disposed at a pitch corresponding to a pixel pitch in a short-side direction (vertical direction) of the liquid crystal display panel 30.

For example, the right-eye alignment region 42A has a plurality of grooves V1 extending in a direction crossing the polarizing axis AX3 of the polarizing plate 31B at 45 degrees as shown in FIGS. 12A and 12B. The left-eye alignment region 42B has a plurality of grooves V2 extending in a direction crossing the polarizing axis AX3 of the polarizing plate 31B at 45 degrees, the direction being perpendicular to the extending direction of the grooves V1, as shown in FIGS. 12A and 12B. For example, when the polarizing axis AX3 of the polarizing plate 31B is in a vertical or horizontal direction, each of the grooves V1 and V2 extend in an oblique (a 45-degree) direction as shown in FIGS. 12A and 12B. While not shown, when the polarizing axis AX3 of the polarizing plate 31B is in an oblique (a 45-degree) direction, the grooves V1 extend, for example, in a horizontal direction, and the grooves V2 extend, for example, in a vertical direction.

Each groove V1 may extend linearly in one direction, or, for example, may extend in one direction in a fluctuating (meandering) manner. A cross section of each groove V1 shows, for example, a V shape. Similarly, a cross section of each groove V2 shows, for example, a V shape. In other words, a total cross section of the right-eye alignment region 42A and the left-eye alignment region 42B shows a saw-tooth shape. In such a groove structure, a pitch is preferably small, several micrometers or less, and more preferably several hundred nanometers or less. For example, such a shape is collectively formed by transfer using a mold. The alignment film 42 may be a photo-alignment film formed by polarized-UV irradiation, instead of having the above groove structure. The photo-alignment film may be manufactured by beforehand coating a material, which aligns in a polarized direction of polarized UV when the material is irradiated with the polarized UV, and then irradiating the right-eye alignment region 42A and the left-eye alignment region 42B with UV light polarized in different directions.

The phase difference layer 43 is a thin layer having optical anisotropy. For example, the phase difference layer 43 is provided on a surface of the right-eye alignment region 42A and of the left-eye alignment region 42B. For example, the phase difference layer 43 has two kinds of phase difference regions (right-eye phase-difference region 43A and left-eye phase-difference region 43B) having different slow axis directions, as shown in FIG. 11.

The right-eye phase-difference region 43A and the left-eye phase-difference region 43B have, for example, a belt-like shape extending in a common, one direction (horizontal direction) each, and are alternately disposed in a short-side direction (vertical direction) of the right-eye phase-difference region 43A or the left-eye phase-difference region 43B.

For example, the right-eye phase-difference region 43A has a slow axis AX6 in a direction crossing the polarizing axis AX3 of the polarizing plate 31B at 45 degrees as shown in FIGS. 4A and 4B and FIG. 11. For example, the left-eye phase-difference region 43B has a slow axis AX7 in a direction crossing the polarizing axis AX3 of the polarizing plate 31B at 45 degrees, the direction being perpendicular to the slow axis AX6, as shown in FIGS. 4A and 4B and FIG. 11. For example, when the polarizing axis AX3 of the polarizing plate 31B is in a vertical or horizontal direction, each of the slow axes AX6 and AX7 is in an oblique (a 45-degree) direction as shown in FIGS. 4A and 4B and FIG. 11. While not shown, when the polarizing axis AX3 of the polarizing plate 31B is in an oblique (a 45-degree) direction, the slow axis AX6 extends, for example, in a horizontal direction, and the slow axis AX7 extends, for example, in a vertical direction. The slow axis AX6 is in an extending direction of the grooves V1, and the slow axis AX7 is in an extending direction of the grooves V2.

Furthermore, for example, the slow axis AX6 is in the same direction as a direction of the slow axis AX4 of the right-eye phase-difference plate 11A of the polarized glasses 2, the direction being different from a direction of the slow axis AX5 of the left-eye phase-difference plate 12A of the polarized glasses 2. The slow axis AX7 is in the same direction as the direction of the slow axis AX5, the direction being different from the direction of the slow axis AX4, for example.

For example, the phase difference layer 43 includes a polymerized polymer liquid crystal material. That is, the phase difference layer 43 is fixed in alignment state of liquid crystal molecules. A material is selected in accordance with factors such as phase transition temperature (liquid crystal phase to isotropic phase), a refractive-index wavelength dispersion characteristic of a liquid crystal material, a viscosity characteristic, and process temperature, and used as the polymer liquid crystal material. However, the polymer liquid crystal material preferably has an acryloyl group or a methacryloyl group as a polymerization group from the viewpoint of transparency. In addition, a material, having no methylene spacer between a polymeric functional group and a liquid crystal framework, is preferably used as the polymer liquid crystal material. This is because alignment treatment temperature is lowered by using the material in a manufacturing process. Thickness of the phase difference layer 43 is, for example, 1 μm to 2 μm. When the phase difference layer 43 is configured of a polymerized polymer liquid crystal material, the phase difference layer 43 need not be configured only by the polymerized polymer liquid crystal material, and may partly include an unpolymerized liquid crystalline monomer. This is because the unpolymerized liquid crystalline monomer in the phase difference layer 43 aligns in a direction similar to an alignment direction of liquid crystal molecules around the monomer, and has an alignment characteristic similar to that of the polymer liquid crystal material.

In the phase difference layer 43, major axes of liquid crystal molecules are arranged along the extending direction of the grooves V1 near a boundary between each groove V1 and the right-eye phase-difference region 43A, and major axes of liquid crystal molecules are arranged along the extending direction of the grooves V2 near a boundary between each groove V2 and the left-eye phase-difference region 43B. That is, alignment of liquid crystal molecules is controlled depending on shapes of the grooves V1 and V2 and extending directions thereof, leading to setting of an optical axis of each of the right-eye phase-difference region 43A and the left-eye phase-difference region 43B.

In the phase difference layer 43, a retardation value of each of the right-eye phase-difference region 43A and the left-eye phase-difference region 43B is set by adjusting a compositional material and thickness of each of the right-eye phase-difference region 43A and the left-eye phase-difference region 43B. When the base 41 causes phase difference, the retardation value is preferably set in consideration of the phase difference caused by the base 41. In this embodiment, the right-eye phase-difference region 43A and the left-eye phase-difference region 43B are configured of the same material with the same thickness, so that absolute values of retardation of the regions are equal to each other.

(1.3 Basic Operation)

Next, an example of basic operation in image display of the display device 2 of the embodiment is described with reference to FIGS. 5A and 5B to FIGS. 8A and 8B.

First, while light illuminated from the backlight 10 is incident on the liquid crystal display panel 30, a parallax signal as an image signal, including a right-eye image component and a left-eye image component, is inputted to the liquid crystal display panel 30. Then, right-eye image light L1 is outputted from pixels in odd rows (FIGS. 5A and 5B or FIGS. 6A and 6B), and left-eye image light L2 is outputted from pixels in even rows (FIGS. 7A and 7B or FIGS. 8A and 8B).

Then, each of the right-eye image light L1 and the left-eye image light L2 is converted into elliptically polarized light by the right-eye phase-difference region 43A and the left-eye phase-difference region 43B of the phase difference element 40, and the converted polarized light transmits through the base 41 of the phase difference element 40, and then outputted to the outside from the image display surface 2A of the display device 2. Then, light outputted to the outside of the display device 2 enters the polarized glasses 1, and is returned from the elliptically polarized light to linearly polarized light by the right-eye phase-difference plate 11A and the left-eye phase-difference plate 12A, and then enters the polarizing plates 11B and 12B.

In the light entering the polarizing plates 11B and 12B, a polarizing axis of light corresponding to the right-eye image light L1 is parallel to the polarizing axis AX1 of the polarizing plate 11B and perpendicular to the polarizing axis AX2 of the polarizing plate 12B. Therefore, in the light entering the polarizing plates 11B and 12B, the light corresponding to the right-eye image light L1 transmits only through the polarizing plate 11B and thus arrives at a right eye of an observer (FIGS. 5A and 5B or FIGS. 6A and 6B).

In the light entering the polarizing plates 11B and 12B, a polarizing axis of light corresponding to the left-eye image light L2 is perpendicular to the polarizing axis AX1 of the polarizing plate 11B and parallel to the polarizing axis AX2 of the polarizing plate 12B. Therefore, in the light entering the polarizing plates 11B and 12B, the light corresponding to the left-eye image light L2 transmits only through the polarizing plate 12B and thus arrives at a left eye of the observer (FIGS. 7A and 7B or FIGS. 8A and 8B).

In this way, light corresponding to the right-eye image light L1 arrives at a right eye of an observer, and light corresponding to the left-eye image light L2 arrives at a left eye of the observer. As a result, the observer virtually recognizes a stereoscopic image on the image display surface 2A of the display device 2.

(1.4 Advantages)

In this embodiment, the right-eye phase-difference plate 11A and the left-eye phase-difference plate 12A of the polarized glasses 1 are configured of a material having a photoelastic coefficient of less than 80*10⁻¹²/Pa. Consequently, even when the right-eye phase-difference plate 11A and the left-eye phase-difference plate 12A are manufactured while being applied with stress during manufacturing, the stress does not cause significant change in birefringence. Therefore, for example, even when the right-eye optical element 11 and the left-eye optical element 12 of the polarized glasses 1 are formed into a curved shape projecting to a display device 2 side as shown in FIGS. 3 and 9, a change in an optical characteristic due to stress is reduced compared with in the past. As a result, the right-eye optical element 11 and the left-eye optical element 12 are improved in design, or a shape of the frame 13 of the polarized glasses 1 is designed relatively freely. Consequently, the degree of freedom in design is improved.

Moreover, in the embodiment, when the curvature A of the light incidence surface S1 of the polarized glasses 1 is made larger than the curvature B of the light emitting surface S2 thereof, a visual correction function is added to the polarized glasses 1. When a person, wearing visual correction glasses in its daily life, views a 3D image, the person has been typically necessary to wear polarized glasses on the visual correction glasses. However, when the visual correction function is added to the polarized glasses 1 in the embodiment, a person views a 3D image by wearing only the polarized glasses 1. In this way, in the embodiment, the degree of freedom is improved not only in design but also in function.

### (2. Example)

Next, an example of the polarized glasses 1 of the embodiment is described in comparison to a comparative example.

FIG. 13 shows a measurement result of crosstalk in polarized glasses according to each of the example and the comparative example. In the figure, white bars show values (crosstalk of left-eye image light) obtained by, when left-eye image light L2 was measured through the polarized glasses 1, dividing luminance measured using a meter for a right eye by luminance measured using a meter for a left eye (see the following expression 1). In the figure, black bars show values (crosstalk of right-eye image light) obtained by, when right-eye image light L1 was measured through the polarized glasses 1, dividing luminance measured using a meter for a left eye by luminance measured using a meter for a right eye (see the following expression 2). Slight difference between both crosstalk values is due to variation in manufacturing or measurement errors, and the values are essentially the same.

Crosstalk of left-eye image light=(luminance in the case that left-eye image light L2 is viewed through the right-eye optical element 11)/(luminance in the case that left-eye image light L2 is viewed through the left-eye optical element 12) Equation (1)

Crosstalk of right-eye image light=(luminance in the case that right-eye image light L1 is viewed through the left-eye optical element 12)/(luminance in the case that right-eye image light L1 is viewed through the right-eye optical element 11) Equation (2)

As the crosstalk is reduced, a stereoscopic display characteristic is improved. Conversely, as the crosstalk is increased, a phenomenon called ghost, where left-eye image light enters a right eye or right-eye image light enters a left eye, occurs more frequently. The ghost causes asthenopia, and makes it difficult for an observer to view a three-dimensional vision in a serious case.

FIG. 13 shows a result obtained in the case that each of the right-eye optical element 11 and the left-eye optical element 12 of the polarized glasses 1 had a curve having a dimension of 2C, 6C, or 8C. 2C shows a curvature of 261.5 mm, and 6C shows a curvature of 87.2 mm. 8C shows a curvature of 65.4 mm as described before. In the example and the comparative example, a hot press method was used to curve each of the right-eye optical element 11 and the left-eye optical element 12. It is to be noted that an insert injection molding may also be used, other than the hot press as the method to curve each element.

It can be understood from FIG. 13 that the crosstalk was increased with decreasing curvature (namely, as a curve became sharper) in each of the example and the comparative example. However, in the comparative example, crosstalk exceeded 3% below which practically no problem occurs, in 6C and 8C. In contrast, in the example, crosstalk was less than 3% in 2C to 8C, showing that the polarized glasses 1 are practically useable even in 6C and 8C.

### (3. Modifications)

While the embodiment has been illustrated with a case where the phase-difference regions (right-eye phase-difference region 43A and left-eye phase-difference region 43B) of the phase difference element 40 extend in a horizontal direction, the regions may extend in a direction other than the horizontal direction. For example, while not shown, the phase-difference regions (right-eye phase-difference region 43A and left-eye phase-difference region 43B) of the phase difference element 40 may extend in a vertical direction.

While the embodiment or the modification has been illustrated with a case where the phase-difference regions (right-eye phase-difference region 43A and left-eye phase-difference region 43B) of the phase difference element 40 extend in a horizontal or vertical direction, for example, while not shown, the regions may be arranged two-dimensionally in both the horizontal and vertical directions.

While description has been made hereinbefore on a case where the polarized glasses 1 are of a circularly-polarized light type and the display device 2 is a display device for the circularly-polarized light glasses, the application may be applied to a case where the polarized glasses 1 are of a linearly-polarized light type and the display device 2 is a display device for the linearly-polarized light glasses.

In this specification, “uniform”, “parallel”, “perpendicular”, “vertical” or “the same direction” includes approximately uniform, approximately parallel, approximately perpendicular, approximately vertical or approximately the same direction, respectively, within a scope without impairing the effects of the technology. For example, errors caused by various factors such as manufacturing errors and variation may be included.

Also, as used herein, the term “plate” may be used interchangeably with the term “sheet”.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. A stereoscopic image observation optical-element, comprising:
a laminated member including a λ/4 phase-difference member and a polarizing member, the λ/4 phase-difference member being provided on a light incidence surface side and having a slow axis in a first direction, and the polarizing member being provided nearer to a light emission side than the λ/4 phase-difference member and having a transmission axis in a direction crossing the first direction at substantially 45 degrees,
wherein the laminated member has a curved shape projecting to the light incidence surface side, and
the λ/4 phase-difference member is configured of a material having a photoelastic coefficient of less than about 80*10⁻¹²/Pa.

2. The stereoscopic image observation optical-element according to claim 1, wherein the material of the λ/4 phase-difference member has the photoelastic coefficient of about 50*10⁻¹²/Pa or less.

3. The stereoscopic image observation optical-element according to claim 2, wherein the material of the λ/4 phase-difference member has the photoelastic coefficient of about 30*10⁻¹²/Pa or less.

4. The stereoscopic image observation optical-element according to claim 1, wherein the material of the λ/4 phase-difference member includes a modified polycarbonate.

5. The stereoscopic image observation optical-element according to claim 1, wherein the laminated member has a curvature of about 65.4 mm or more.

6. Stereoscopic image observation glasses, comprising:
a first optical element for a right eye;
a second optical element for a left eye; and
a frame supporting the first optical element and the second optical element,
the first optical element including a first laminated member having a first λ/4phase-difference member and a first polarizing member, the first λ/4 phase-difference member being provided on a light incidence surface side and having a slow axis in a first direction, and the first polarizing member being provided nearer to a light emission side than the first λ/4 phase-difference member and having a transmission axis in a direction crossing the first direction at substantially 45 degrees,
the second optical element including a second laminated member having a second λ/4 phase-difference member and a second polarizing member, the second λ/4phase-difference member being provided on a light incidence surface side and having a slow axis in a second direction crossing the first direction, and the second polarizing member being provided nearer to a light emission side than the second λ/4 phase-difference member and having a transmission axis in a direction crossing the second direction at substantially 45 degrees,
wherein each of the first laminated member and the second laminated member has a curved shape projecting to the light incidence surface side, and
each of the first λ/4 phase-difference member and the second λ/4 phase-difference member is configured of a material having a photoelastic coefficient of less than about 80*10⁻¹²/Pa.

7. The stereoscopic image observation glasses according to claim 6, wherein each of the first laminated member and the second laminated member has a curvature of about 65.4 mm or more.

8. A stereoscopic image display system, comprising:
a stereoscopic image display device; and
stereoscopic image observation glasses provided separately from the stereoscopic image display device,
the stereoscopic image observation glasses including:
a first optical element for a right eye;
a second optical element for a left eye; and
a frame supporting the first optical element and the second optical element,
the first optical element including a first laminated member having a first λ/4 phase-difference member and a first polarizing member, the first λ/4 phase-difference member being provided on a light incidence surface side and having a slow axis in a first direction, and the first polarizing member being provided nearer to a light emission side than the first λ/4 phase-difference member and having a transmission axis in a direction crossing the first direction at substantially 45 degrees,
the second optical element including a second laminated member having a second λ/4 phase-difference member and a second polarizing member, the second λ/4 phase-difference member being provided on a light incidence surface side and having a slow axis in a second direction crossing the first direction, and the second polarizing member being provided nearer to a light emission side than the second λ/4 phase-difference member and having a transmission axis in a direction crossing the second direction at substantially 45 degrees,
wherein each of the first laminated member and the second laminated member has a curved shape projecting to the light incidence surface side, and
each of the first λ/4 phase-difference member and the second λ/4 phase-difference member is configured of a material having a photoelastic coefficient of less than about 80*10⁻¹²/Pa.
